(19) United States
(12) Patent Application Publication
(10) Pub. No.: US 2007/0103612 A1
(43) Pub. Date: May 10, 2007

(54) Programmable solid state photolithography mask

(76) Inventor: Nancy Ellen Johnson Lumpkin, Waterfall (AU)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 11/593,163

(22) Filed: Nov. 3, 2006

Related U.S. Application Data
(60) Provisional application No. 60/733,696, filed on Nov. 4, 2005.

(51) Int. Cl. G02F 1/136

(52) U.S. Cl. 349/42

(57) ABSTRACT

This invention relates to electrically programmable photolithography masks and to structures fabricated by such masks. An electrically programmable photolithography mask with memory to retain a programmed pattern after programming is described. The mask comprises: a single, photolithographic mask plate to provide a mechanical support for said mask; an array of pixels each pixel comprising an electrically programmable solid-state electro-opaque structure fabricated on said mask plate; a plurality of row electrodes; a plurality of column electrodes; said row and column electrodes defining said pixels and being configured for addressing individual said electro-opaque pixels for programming said mask to define a pattern of optical modulation by the mask; and a thin film protective covering layer over at least said array of electro-opaque pixels.

This invention relates to electrically programmable photolithography masks and to structures fabricated by such masks.

It is known to provide a programmable liquid crystal arrangement for use as a photolithographic mask as described, for example, in U.S. Pat. No. 4,653,860 and WO91/10170. However such a liquid crystal based device suffers from a severely limited resolution and the resulting structures tend to have rough, poorly defined edges and, often, point defects. Another example of a liquid crystal display based electronically controlled mask is described in U.S. Pat. No. 6,528,217. An alternative structure is described in U.S. Pat. No. 6,600,551, in which a programmable mask comprises a two-dimensional array of solid-state selective amplifiers each comprising regions of permanently opaque material and active regions, control circuitry disposed within the array being provided to selectively control each of the active regions to toggle between an amplifying state and a non-amplifying state. A similar type of approach is described in US 2004/0150865 which describes a programmable photolithographic mask based on semiconductor nano-particle optical modulators. Further background prior art can be found in U.S. Pat. No. 6,093,598, U.S. Pat. No. 5,998,069, WO 2004/053938, US 2003/128347, WO 03/038518, US 2003/214611, US 2002/102479, US 2002/098424, US 2001/049063, U.S. Pat. No. 6,084,656, WO 97/05526, U.S. Pat. No. 4,653,860 and U.S. Pat. No. 6,528,217.

Solutions to some of the above problems are provided in U.S. Pat. No. 6,770,068 which describes the use of electochromic technology for an electro-optical patternable mask for ophthalmic laser surgery. A speculative application of the mask in a photolithography system is mentioned but the inventor has determined that, in practice, the mask described in '068 is unfit for this demanding purpose for a number of reasons including, but not limited to, reasons relating to the basic mask structure, surface flatness, optical transparency, thermal expansion, wavelength choice, compatibility with existing photolithographic exposure systems electrical interface and programming, and pixel size/resolution, in particular the use of large pixels with spaces in between. In particular the sandwich structure of the mask described in this patent introduces an unacceptable level of optical distortion.

According to a first aspect of the invention there is therefore provided an electrically programmable photolithography mask with memory to retain a programmed pattern after programming, the mask comprising: a single, photolithographic mask plate to provide a mechanical support for said mask; an array of pixels each pixel comprising an electrically programmable solid-state electro-opaque structure fabricated on said mask plate; a plurality of row electrodes; a plurality of column electrodes; said row and column electrodes defining said pixels and being configured for addressing individual said electro-opaque pixels for programming said mask to define a pattern of optical modulation by the mask; and a thin film protective covering layer over at least said array of electro-opaque pixels.

In embodiments the use of a single photolithographic mask plate with a multiple layer thin-film based surface structure enables critical requirements relating to mask flatness and uniformity (including thermal expansion) to be met. (In this context, thin-film refers generally to the use of vacuum/sol-gel deposition technology of materials onto a substrate, the materials typically having a thickness of less than 10 μm, more often less than 1 μm). In other than contact mask embodiments the mask preferably further comprises a pellicle mount over the protective thin-film layer, for mounting a pellicle on the mask to inhibit particulate contamination whilst at the same time ensuring that there is a substantially direct optical path from the electro-opaque structures to photoresist to be patterned (that is through only the thin-film protective covering and the pellicle and any intervening gas rather than through the substrate).

Another important feature for a mask suitable for photolithography is a close sub-exposure-wavelength (i.e. less than 100 nm) spacing between electro-opaque pixels of the array. In embodiments this is achieved by means of row and column electrodes, which are positioned above and below the electro-opaque structures or both on the same side of the electro-opaque structures, with a ground plane counter-electrode. In the latter case a proportion of the switching voltage for a said structure may be applied to each of a selected row-column pair so that at the pixel where the selected row and column intersect the combined electric field between the row and column electrodes and the ground plane counter-electrode is sufficient to cause switching of the addressed electro-paque structure.

In embodiments the array of electro-opaque pixels is configured as a plurality of sub-arrays each with a separate set of addressing electrodes. In some embodiments the row and column electrodes for an array or a sub-array are brought out to a set of electrode pads or bumps configured for connection for a probe station probe head. In other embodiments interface circuitry is fabricated on the mask plate to allow quasi-serial addressing of an array or sub-array of pixels (recalling that the pixels themselves are able to retain a programmed state after removal of electrical power). This interface circuitry is preferably positioned so as not to interfere with the operation of standard stepper equipment, for example to avoid standard positions for fiducial alignment markings.

In embodiments providing an electrically programmable photolithography mask with memory facilitates use of the mask in conventional photolithographic equipment. In some preferred embodiments the mask, once programmed, comprises a substantially drop-in replacement for a conventional, fixed mask.

It will be appreciated that in this specification references to optical modulation, transmittance and the like are not limited to light of visible wavelengths but include light of other wavelengths, in particular shorter than visible wavelengths.

In preferred embodiments the electrically programmable structures are solid-state electro-opaque thin-film (active or passive) structures and comprise one or more layers of solid-state material having an optical transmittance responsive to an applied voltage or electric field, for example a thin solid film. In particular in preferred embodiments the solid-state structures include a ceramic or complex oxide with electrically moveable ions and the electrically programmable optical modulation is provided by electrically influenced movement of ions within a structure. The movement of ions in the structure is semi-permanent, so that once programmed the mask pattern is substantially non-volatile. The potential resolution of such a structure is much greater than with LCD-based programmable masks, for example of the order of the wavelength of illuminating light.

The terminology employed in this specification refers to electro-opaque structures rather than electro-chromic materials because, preferably, the structures employed have an optical transmission at least one wavelength less than 500 nm (for example, in the range 200 nm to 500 nm) variable between transmission levels compatible with conventional photoresist threshold levels by using an electric filed applied by the row and column electrodes.

In some preferred embodiments the electro-opaque structure comprises a stack including an electrochromic/electro-opaque material such as tungsten oxide (WO₃), preferably doped, for example with hydrogen (H⁺), lithium (Li⁺), manganese or the like. An adjacent ionic conductor layer may comprise, for example, tantalum oxide (Ta₂O₅) and an ion storage layer adjacent to this may comprise a metal oxide such as nickel oxide or zinc oxide. This structure may be sandwiched between conducting electrodes, for example formed from indium tin oxide (ITO). In other embodiments there is provided a reflection mask, in which case one of the electrodes such as a back electrode may comprise a reflective material such as aluminium.

Some details of fabrication of a solid-state electrochromic device are described in C. Person et al, Solid State Ionics, 165 (2003), pages 73 to 80, hereby incorporated by reference.

Embodiments of the mask may be used as a clear (light) field mask, as a dark field mask, or as a greyscale mask.

Thus in a preferred embodiment the electrically programmable structures define pixels within the one or more solid-state material. The mask may then include separators between adjacent pixels, for example an air gap or glass, silicon monoxide, silicon dioxide or the like, preferably substantially electrically insulating. Depending upon whether the mask is positive or negative (clear or dark field) an opaque material may be employed. The use of separators between pixels of the mask is not essential but helps to confine lateral movement and/or diffusion of ions within some preferred embodiments.

In some preferred embodiments the programmable structure has a plurality of layers and the memory system is implemented using one or more barrier structures between the layers. For example the layers may include one or more of an active material layer, an ionic conductor layer and an ion storage layer, in which case a barrier layer may be disposed between the ionic conductor layer and the ion storage layer. Alternatively one or more barrier layers may be provided within the ionic conductor or within the ion storage layer. Broadly speaking, in embodiments ions can be moved electrically past a barrier and hence substantially trapped to maintain the structure in a desired transmission state.

In embodiments a transmission state of an electro-opaque pixel may comprise one of two states, a first substantially transmissive state and a second substantially opaque state, compatible with conventional photolithographic exposure systems for example transmitting at 80 percent, 90 percent or more and at 20 percent, 10 percent or less at a relevant wavelength or range of wavelengths (for example the range of wavelengths spanning at least 50 nm, 100 mn, 300 nm or more).

In other arrangements embodiments of the mask may be employed to provide a greyscale mask rather than a clear/opaque switching mask, in which case an electrically programmable structure may be programmed to define a plurality of different optical transmission values, either discrete or continuous (for continuous greyscale a variable voltage is applied such that partial coloration of the electrochromatic layer is obtained). For example the memory system may comprise a plurality of barrier structures, and in particular the above mentioned ion storage layer may include a plurality of barrier layers. In this way, for example, ions may be moved past one, two, three or more barriers in a cascade-type structure. Such a structure facilitates provision of multiple greyscale levels for the mask (although this is not essential for a greyscale mask).

A barrier layer may comprise a very thin metal or metal oxide layer (for example zinc oxide or manganese oxide) or some other readily deposited material such as silicon monoxide, silicon dioxide or silicon nitride. Additionally or alternatively a barrier layer may comprise a layer of increased density within an electrically programmable structure, for example formed by sputtering argon into a previously deposited layer to densify a surface region, or a barrier may be formed by some other technique in which a barrier is provided by implanted ions. In embodiments a barrier layer may comprise a quantum barrier arrangement or quantum well. Such a quantum barrier arrangement may comprise a single or multi-layer thin film structure, for example a heterostructure.

The mask plate may comprise a relatively conventional material such as quartz (fused silica), or low-expansion glass or sodium glass or a more exotic material such as silicon-on-insulator or sapphire. Silicon-on-insulator (SOI)/sapphire has the advantage of facilitating the fabrication of electronic devices for addressing the pixel layer structures, such as one or more of a capacitor, transistor and logic circuitry in conjunction with an electrically programmable optical modulation structure. A window is opened up in the silicon for the electro-opaque structures since silicon is opaque at the wavelengths of interest. The addressing peripheral elements can then be fabricated in silicon outside the transmissive insulator/pixel layer structure, for example, in an L-shape, and connected to the pixels via the (row and column) pixel addressing electrodes. Thus in embodiments the memory system may comprise a charge storage device, in particular a floating plate capacitor, along similar lines to a floating gate MOS transistor. Additionally or alternatively the memory system may comprise an active memory circuit, that is including one or more active devices such as a MOS transistor in conjunction with a gate capacitor to store a charge. In this case a mask may include a power supply for the active memory circuit of each pixel comprising, for example, a battery or large value capacitor. Thus, such a battery or capacitor is preferably part of the mask or structure.

In embodiments the mask is designed for operation at one or more of the following wavelengths: 157 nm, 193 nm, 248 nm, 365 nm and 436 nm.

In some preferred embodiments the programmable optical modulation structures are vertical, that is having upper and lower electrodes in a vertical direction through the thickness of the mask, but in variants lateral devices may be employed (with one or more lateral connections, typically spaced apart in the plane of the mask).

As previously mentioned, embodiments of the structure also enable greyscale optical modulation.

In a further aspect the invention provides an electrically programmable photolithography mask with memory to retain a programmed pattern after programming, the mask comprising: a substrate bearing an array of electrically programmable solid state structures for programming to define a pattern of optical modulation to be implemented by said mask; a plurality of electrodes for addressing said structures for said programming; and a memory system associated with each said structure for retaining said pattern of optical modulation after said programming; and

wherein said memory system comprises a charge storage device.

The invention also provides an electrically programmable photolithography mask with memory to retain a programmed pattern after programming, the mask comprising:

a substrate bearing an array of electrically programmable solid state structures for programming to define a pattern of optical modulation to be implemented by said mask;

a plurality of electrodes for addressing said structures for said programming; and

a memory system associated with each said structure for retaining said pattern of optical modulation after said programming; and wherein said memory system comprises an active memory circuit, and wherein said mask includes a power supply for said active memory circuit.

The invention also provides an electrically programmable mask for controlling the transmission of electromagnetic radiation, the mask comprising: a semiconductor-on-insulator substrate including a transmissive region or window, in particular from which semiconductor is substantially absent; an array of pixels each comprising an electrically programmable solid-state structure; and a plurality of electrodes for addressing said pixels to program said mask with a pattern of transmission of said electromagnetic radiation.

Preferably the semiconductor comprises silicon, and preferably the electrodes are fabricated in a silicon-bearing-region of the silicon-on-insulation substrate. Preferably the mask further comprises drive circuitry coupled to the electrodes to drive the electrodes, likewise fabricated in a silicon-bearing region of the substrate.

In embodiments the individual pixels have individually adjustable states of transmission, for example between a maximum transmitting (on) and a maximum blocking (off) state. The solid state structure of a pixel may comprise an electro-opaque material (which here includes an electrochromic material) to provide memory, in embodiments providing substantially bistable transmission between a coloured or opaque state at a wavelength of interest and a substantially transmitting state at a wavelength of interest. Some example wavelengths at which the mask may be used are described elsewhere in this application, but applications of the mask are not limited to these wavelengths. In particular applications of embodiments of this aspect of the invention are not limited to photolithography but include, for example, medical and ophthamological applications (for example to provide a controllable mask for use in laser eye surgery for contouring the cornea through controlled ablation with an ultra-violet, for example excimer laser). Other applications of embodiments of this aspect of the invention include, for example, medical data digitisation, and programmable mirrors, shutters and lenses (including Fresnel lenses).

In embodiments substantially conventional silicon-on-insulator (SOI) technology may be employed including, but not limited to, technologies such as wafer bonding, Unibond and SIMOX (separation by implantation of oxygen); other technologies such as silicon-on-diamond and silicon-on-sapphire may also be suitable in embodiments.

In another aspect the invention provides an electro-optical mask including an array of pixels, each pixel including first and second regions between which ions are reversibly moveable and having an opaqueness depending on the relative concentration of ions in one or more of the first and second regions and wherein, in use, the application of a voltage across the first and second regions is used to control the concentration of ions in the first and second regions and hence the opaqueness of the pixel; characterised in that it further includes a barrier between the first and second regions for impeding the movement of ions between the first and second regions in at least one direction.

Again, with this aspect of the invention, applications are not limited to photolithography but include medical and other applications, for example as mentioned in connection with the previously described aspect of the invention above.

In these and other aspects of the invention, a LISICON-type ionic conductor may be employed, for example, as a replacement for a Nb₂O₅ layer. This may be formed in vacuum, optionally in series with (the) other metal transition oxides. This material provides the advantage of fast ion transport.

The invention further provides a method of fabricating a three-dimensional structure, the method comprising: programming an electrically programmable photolithography mask to define a greyscale pattern of modulation on the mask for fabricating said structure; coating a wafer with a photosensitive polymer or photoresist; exposing said wafer using said programmed greyscale mask; and developing said exposed wafer to define a three-dimensional shape using said polymer or photoresist.

Preferably the optically contoured photoresist has at least a (surface) region of substantially continuous, unstepped surface contour variations.

In embodiments of the above described technique either positive or negative photoresist may be employed. Examples of suitable photosensitive materials include PMMA, PMAA, Polymethylglutamide, Polyimide, and combinations of these. A silicon/semiconductor or other wafer may be employed and embodiments of the method may be used, for example, for MEMS (Micro Electro Mechanical Systems) or microfluidic device fabrication. Embodiments of the above described method provide a substantially continuously varying surface contour, or at least a surface height which, although constant over a pixel area, is substantially continuously variable. Embodiments of the method may thus be employed to fabricate two dimensional or three-dimensional structures. Such structures have applications in a range of fields not limited to photolithography, for example including illumination and/or imaging of biological samples, proteomics, diagnostics, medical applications, and other techniques involving patterning, typically using a laser.

The invention further provides a system for fabricating a three-dimensional structure, the system including: an electrically programmable photolithography mask; and

a system for programming an electrically programmable photolithography mask to define a greyscale pattern of modulation on the mask for fabricating said structure.

In some preferred embodiments the mask is configured as a drop-in replacement for a conventional (non-programmable) photolithography mask so as to be compatible with industry standard tools, in particular steppers. Thus in preferred embodiments the mask is either four, five or six inches square and of a thickness compatible with industry standard tools such as 0.25 inches thick. The total thickness of the electrodes and electrode-opaque stack is preferably less than 1 μm, typically in the range 250 nm to 350 nm total film thickness. Preferably an electro-opaque stack has a transmission variable between five percent and 95 percent at one of the design wavelengths mentioned above. Preferably the pixels substantially abut one another, that is the space between adjacent pixels is preferably less than 100 nm, more preferably less than 50 nm to provide a sharp definition of a photolithography pattern. Preferably a pixel has a maximum lateral dimension of less than 1 μm, more preferably less than 0.5 μm, most preferably less than 0.25 μm. A mask may comprise 10⁹ pixels or more.

In a variant of the above-described technology, a mask according to the invention is contemplated in which the thin film protective layer is omitted.

In embodiments, features from the different above-described aspects of the invention (both masks and methods) may be combined.

These and other aspects of the invention will be now be further described, by way of example only, with reference to the accompanying figures in which:

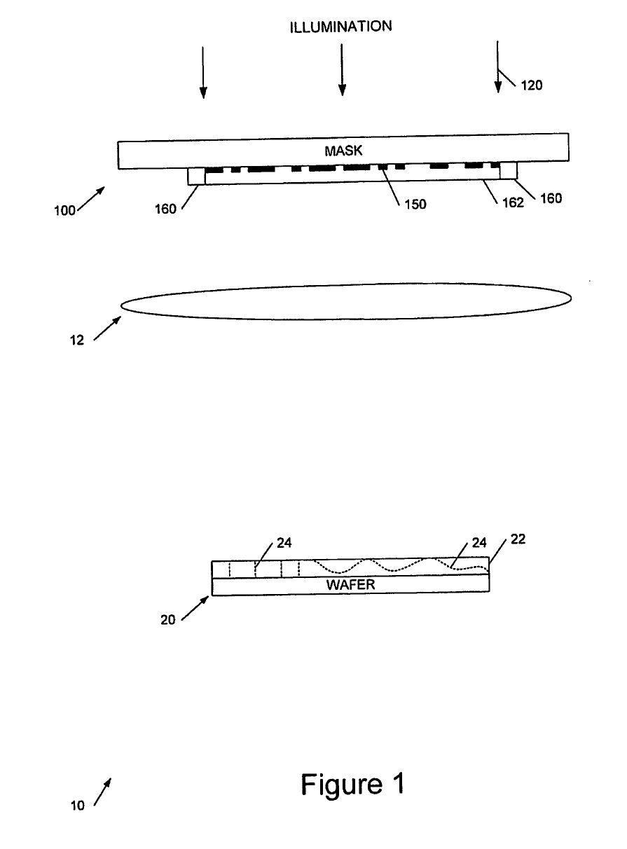

FIG. 1 shows a photolithography system suitable for use with an embodiment of a mask according to the present invention;

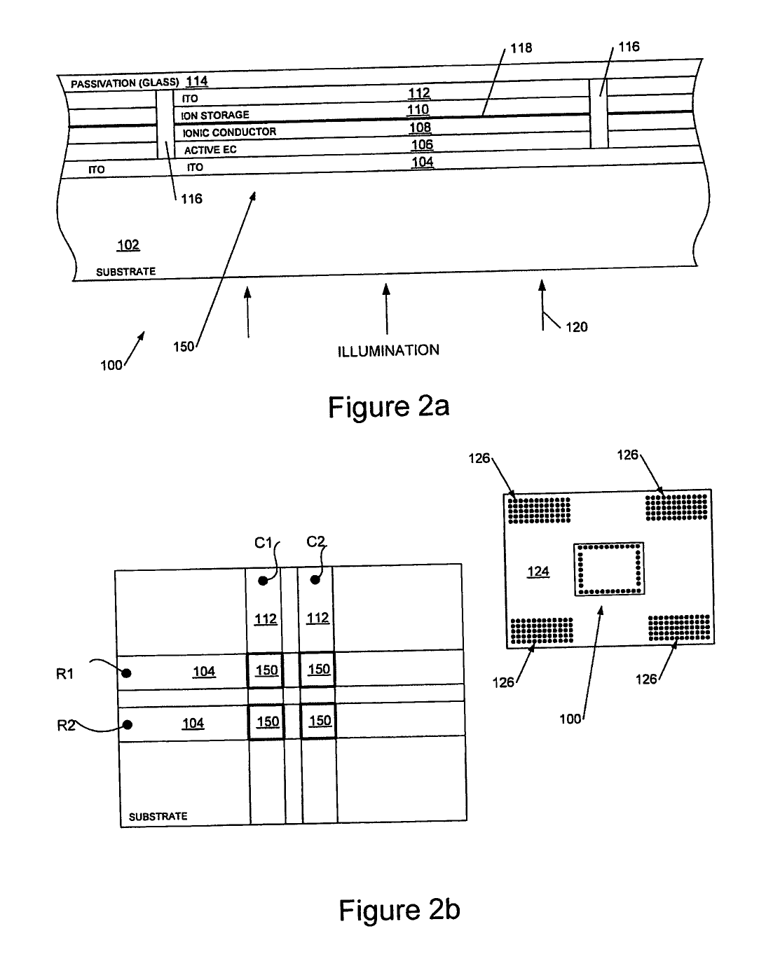

FIGS. 2a and 2b show, respectively, a vertical cross-sectional view and a view from above of an embodiment of a mask according to an aspect of the invention;

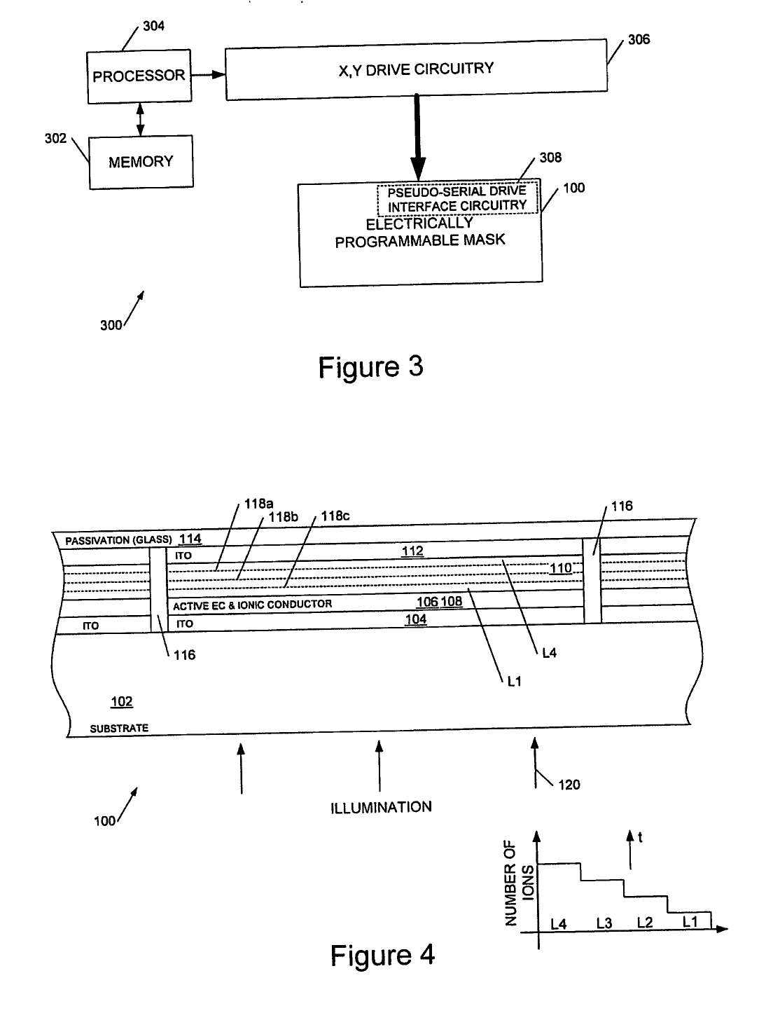

FIG. 3 shows a programming system for the mask of FIG. 2;

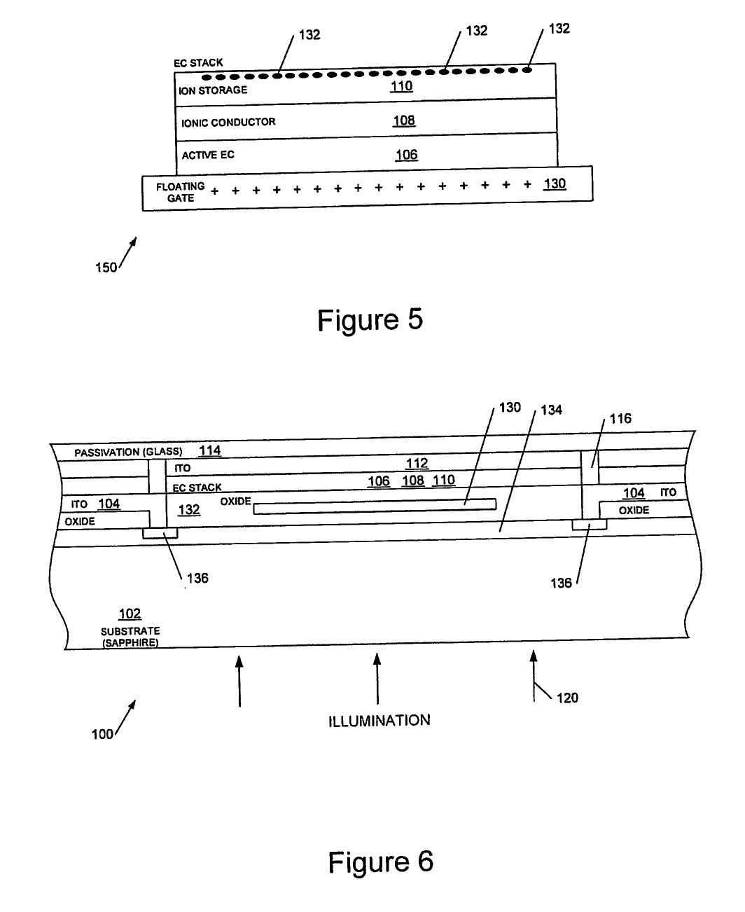

FIG. 4 shows a second embodiment of a mask according to an aspect of the present invention;

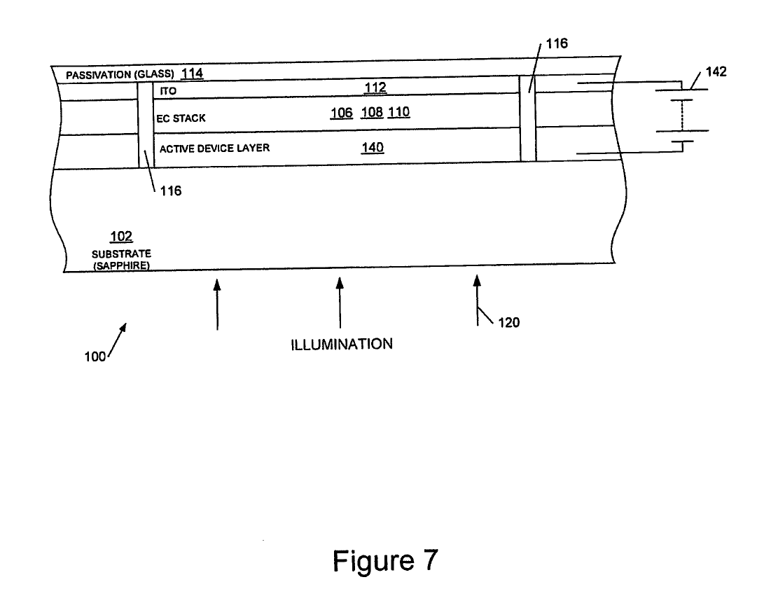

FIG. 5 shows a schematic diagram of a third embodiment of a mask according to an aspect of the present invention;

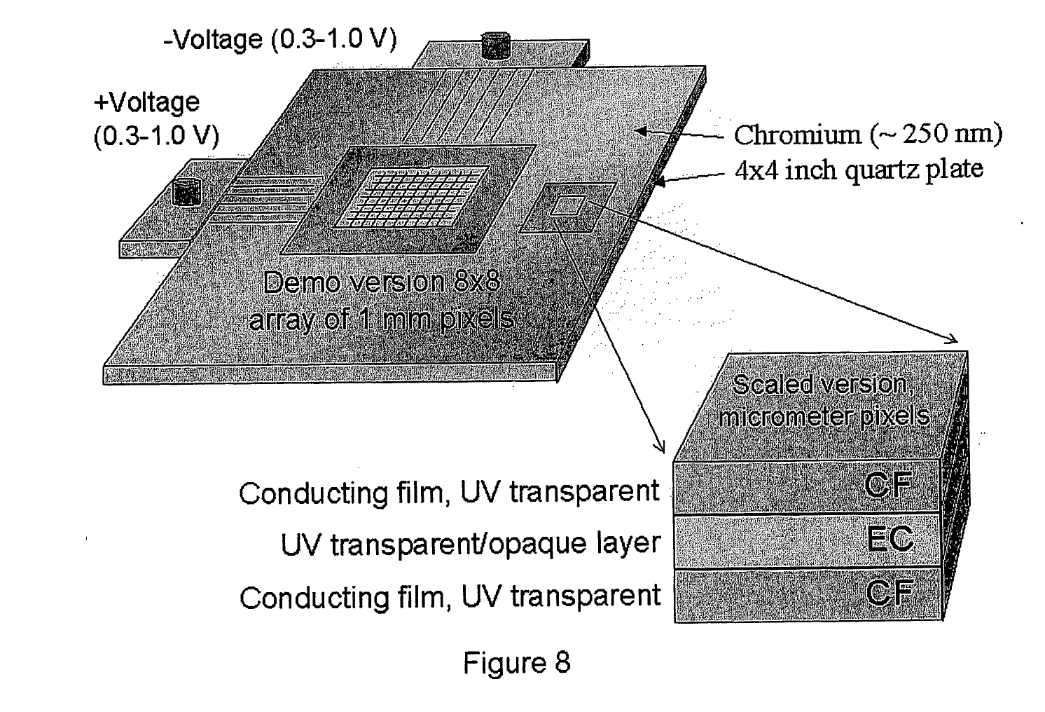

FIG. 6 shows a detailed vertical cross-sectional view of a mask according to a third embodiment of an aspect of the present invention;

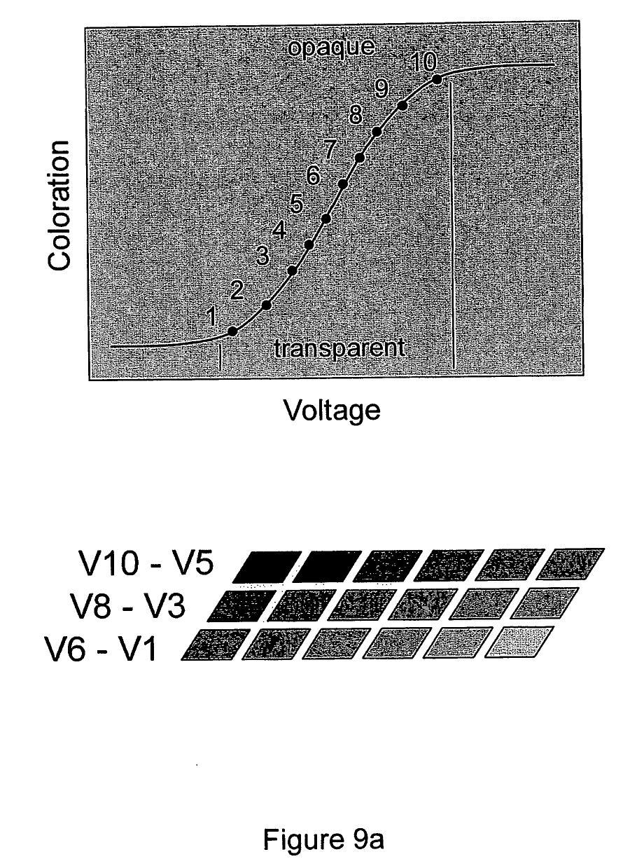

FIG. 7 shows a vertical cross-sectional view of a fourth embodiment of an aspect of the invention;

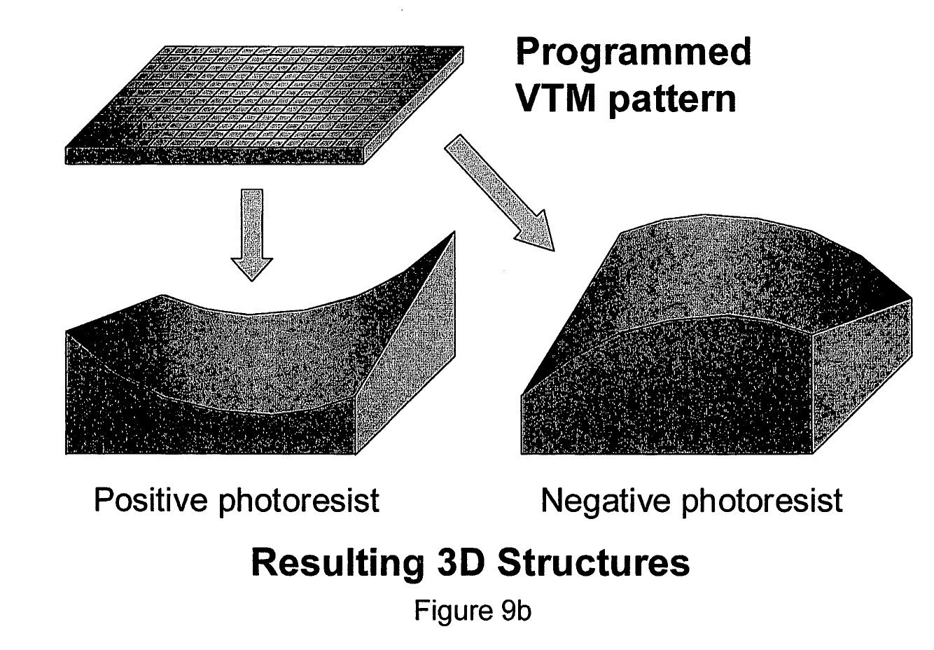

FIG. 8 shows a schematic diagram of a first demonstration mask embodying an aspect of the present invention;

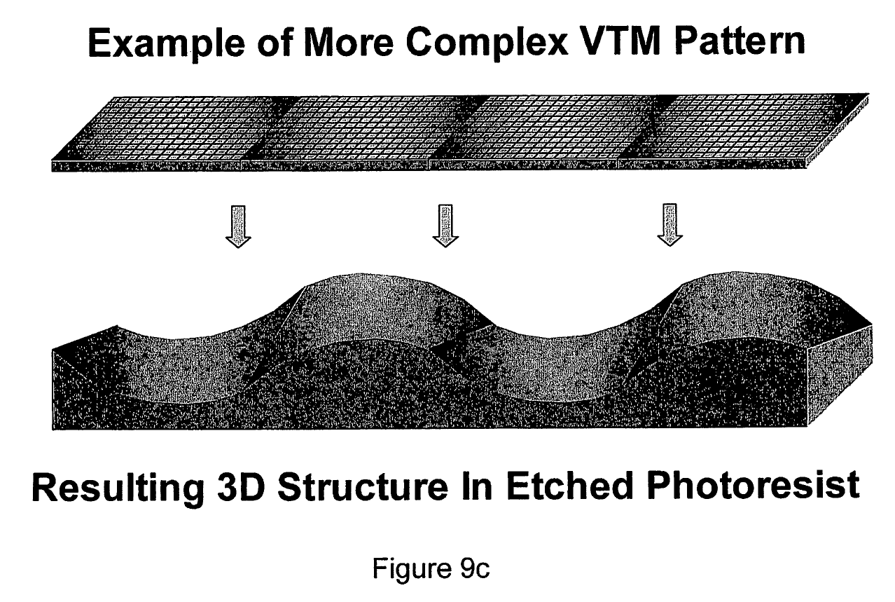

FIGS. 9a to 9c show respectively, an illustration of the basic concept of greyscale pixel programming, three dimensional structure formation in positive and negative photoresist materials via chemical etching, and the formation of more complex structures in large areas of photoresist; and

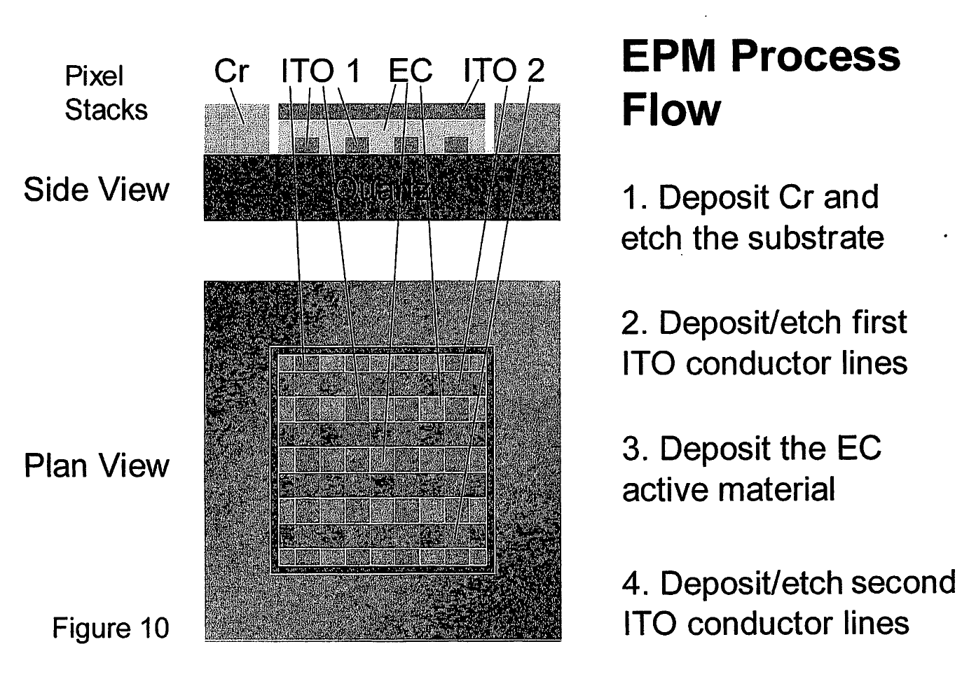

FIG. 10 shows an example fabrication process for an embodiment of a mask according to an aspect of the invention.

Referring to FIG. 1, this shows a photolithography system 10 comprising an infrared, visible or ultraviolet illumination system (not shown) providing illumination 120 to an electrically programmable mask 100. The mask 100 has a pellicle mount 160 bearing a pellicle 162 and an array of electro-opaque structures 150. The pattern of the mask formed by electro-opaque structures 150 is projected onto a wafer 20 by a lens 12 (or other projection system). Typically the pattern of the mask is reduced in scale by the optical projection system to form a reduced scale image of the pattern on photoresist 22 deposited on wafer 20. This photoresist is developed after exposure to leave a pattern 24, which may be the end result of the process or which may be employed for further wafer processing steps such as selective modification and/or deposition of additional layers of material. As can be seen in FIG. 1 embodiments of the mask we describe are able to produce regions of substantially continuously variable surface profile by greyscale patterning of mask 100 (where elements of the mask have a discreet or substantially continuously variable transmission, according to their programming.

Referring next to FIG. 2a, in an embodiment mask 100 comprises a mask plate 102, for example a quartz maskplate, on which is provided a transparent, conducting layer of indium tin oxide (ITO) 104, patterned to define pixels as shown in FIG. 2b. An active electrochromic (EC) or electroopaque layer 106 is deposited over ITO layer 104; this may comprise, for example, tungsten oxide (WO₃) or in some preferred embodiments an ionic conductor layer 108, for example comprising tantalum oxide (Ta₂O₅), followed by an ion storage layer 110, for example of nickel oxide. A further ITO layer 112 is deposited over this electrochromic/electro-opaque stack to provide a second electrode for each pixel, again as shown in FIG. 2b. Preferably a passivation layer 114 such as glass is used to encapsulate the structure. It will be appreciated that the diagram of FIG. 2a is not to scale. Typical thicknesses for experimental devices are on the order of 100 to 200 nm for the transparent electrodes (e.g. ITO), 40 to 50 nm for the ion storage layer (e.g. NiO), and 70 to 120 nm each for the ion conducting and electrochromic layers (e.g. Ta₂O₅ and WO₃).

In some preferred embodiments the EC film is substantially continuous and pixels of the mask are defined by the row and column electrodes. However spacers 116 may be provided between adjacent pixels to reduce diffusion of ions between pixels. Although these may simply comprise open regions preferably they are formed from a transparent material such as glass, silicon monoxide or silicon dioxide for a clear field mask or opaque material such as doped glass for a dark field mask.

Referring to FIG. 2b this shows, schematically, how row and column connections are made to the pixels 150 by means of bond pads and wires. Thus, for example, the mask 100 may be mounted on a support 124 bearing a plurality of connection regions 126 and bond pads on the mask may be connected to these connection regions. Connections to connection regions 126 may be made by step and repeat probe heads; alternatively a probe head may be employed to make connection directly with pads on the mask 100.

Referring again to FIG. 2a, the structure preferably includes a barrier 118 between the ionic conductor 108 and ion storage 110 layers comprising, for example, a thin layer of tantalum palladium or platinum and/or sputtered (plasma implanted) argon ions in an upper surface region of ionic conductor layer 108. In a preferred embodiment the active electrochromic layer 106 is doped with lithium ions and these are transported through barrier 118 when around 0.3 to 1.0 volts is applied across the structure and trapped in the ion storage layer 110. In this way, after the mask has been programmed the pattern is retained even when the power used to program the mask is removed. This means that embodiments of the mask can serve as a drop-in replacement for conventional, permanent masks. The time to program a pixel depends upon the dimensions of the structure, thickness and number of barriers, electric fields applied and the like. Once the lithium ions have been trapped in the ion storage layer, this layer becomes substantially dark; typically a variation in transmission levels compatible with conventional photoresist threshold levels. Preferably the ion storage layer is orientated towards the wafer with illumination as shown, to reduce diffraction effects. In variants the barrier 118 may comprise a quantum well structure such as a multi layer hetero structure.

It will be appreciated that depending upon the dimensions of the structure, materials employed, electric field applied and the like a variable opaqueness of ion storage layer 110 is achieved and in this way a grey scale mask may be provided. This allows the formation of novel photoresist structures, in particular having at least regions where the height of developed photoresist above the wafer is continuously variable (between upper and lower limits, for example defined by the thickness of the photoresist layer) by the continuously variable mask transmission for the region.

FIG. 3 shows an example of a programming system 300 for the mask of FIG. 2. In this example the programming system comprises a memory 302 storing a programme to be patterned into mask 100, coupled to a processor 304 which outputs a signal to X-Y drive circuitry 306 to drive mask 100 to program the mask with the pattern stored in memory 302. Optionally mask 100 may include circuitry 308 fabricated on the mask plate as a substrate (for example around part of the edge of the optical field of view for transmission) to allow the drive circuitry 306 to drive the mask using a pseudo-serial bus. Preferably the mask is then fabricated on an SOI-type mask plate substrate, the silicon being removed from the optical modulating (optically active) part of the substrate prior to fabrication of the EC stack.

FIG. 4 shows a variant of the mask of FIG. 2 in which like elements are indicated by like reference numerals. In the mask of FIG. 4 a plurality of barriers 118 a-c are provided within the ion storage layer 10 to divide this into four intermediate layers L1-L4. The inset graph shows how the number of ions in each of these layers increases over time when the structure of FIG. 4 is programmed. This facilitates implementation of a grey scale mask and can also enhance the permanence of the stored pattern.

Referring next to FIG. 5 this shows the principle behind an attractive, less preferred embodiment of a transparent electrically programmable mask. In the arrangement of FIG. 5 a floating gate 130 is employed to drive ions 132 into the ion storage layer 110 of the electrochromic stack. The floating gate 130 stores electrical charge and this provides a non-volatile memory storage element for a pixel structure 150.

FIG. 6 shows details of implementation of the FIG. 5 system, in which floating gate 130 is formed as a region within an oxide layer 132 (similarly to conventional EEPROM). Under oxide layer 132 is (in this example) an n-type transparent oxide layer 134 with p+ connections 136 to ITO 104. In a similar manner to floating gate non-volatile memory storage technology, a voltage may be applied between connections 136 to drive charge through oxide layer 132 onto floating gate 130, which is then maintained by the insulating oxide when the programming voltage is removed. Preferably the mask of FIG. 6 is formed on a sapphire or silicon-on-insulator substrate.

FIG. 7 shows a further alternative embodiment of a mask 100 in which a low voltage battery 142, capacitor or other electrical power storage device is used to provide power to an active device layer 140 (in this simplified illustration vias, and details of layer 140 are omitted for clarity). Any of a range of active and/or passive components may be fabricated in active device layer 140 including, but not limited to transistors, capacitors, and logic circuitry. In a simple example the active device layer 140 may comprise, for each pixel, a field effect MOS transistor with a charge storage capacitor coupled to the gate of this transistor to provide active, non-volatile storage for each pixel element to retain a programmed pattern. However where such an active device is collocated with a pixel the mask may be made with all transparent layers (i.e. a transmission mask) or with a reflection layer (i.e. a reflection mask).

FIG. 8 illustrates a simple demonstration of a mask in which an 8×8 array of 1 mm square pixels is fabricated on a quartz plate, with a 250 nm chromium layer to provide connections to a voltage supply, typically in the range 0.3 to 1.0 volts. Each pixel comprises a pair of electrodes sandwiching an electrochromic or electro-opaque stack; the electrodes are formed from uv—transparent conducting film.

FIG. 9a illustrates an example of possible voltage response function for variable transmission mask (VTM) patterns, with a usable range ΔV, showing a graph of colouration against voltage and example patterns for 10 voltages. FIG. 9b shows example resulting 3D structures from a programmed example pattern, and FIG. 9c shows and example of a more complex VTM pattern and a resulting 3D structure in etched photoresist.

No doubt many other effective alternatives will occur to the skilled person and it will be understood that the invention is not limited to the described embodiments but encompasses modifications apparent to those skilled in the art lying within the spirit and scope of the claims appended hereto.

I claim:

1. An electrically programmable photolithography mask with memory to retain a programmed pattern after programming, the mask comprising:
a single, photolithographic mask plate to provide a mechanical support for said mask;
an array of pixels each pixel comprising an electrically programmable solid-state electro-opaque structure fabricated on said mask plate;
a plurality of row electrodes;
a plurality of column electrodes;
said row and column electrodes defining said pixels and being configured for addressing individual said electro-opaque pixels for programming said mask to define a pattern of optical modulation by the mask; and
a thin film protective covering layer over at least said array of electro-opaque pixels.

2. An electrically programmable photolithography mask as claimed in claim 1 wherein said array of electro-opaque pixels comprises a plurality of sub-arrays each having a respective set of said row and column electrodes for addressing the sub-array.

3. An electrically programmable photolithography mask as claimed in claim 1 further comprising at least one set of electrode connections for said row and column electrodes, said set of connections comprising an array of electrode pads for connection with a probe station probe head.

4. An electrically programmable photolithography mask as claimed in claim 1 further comprising interface circuitry fabricated on said mask plate, said interface circuitry having an input being configured to receive pattern data and to drive said row and column electrodes to program said electro-opaque pixels in accordance with said pattern data.

5. An electrically programmable photolithography mask as claimed in claim 1 further comprising a substantially continuous electrode plane configured to address a plurality of rows and columns of said pixels of said array; and wherein said row and column electrodes and said electrode plane are disposed on opposite sides of said electro-opaque structures of said pixels of said array.

6. An electrically programmable photolithography mask as claimed in claim 1 further comprising a pellicle amount for mounting a pellicle over said protective covering layer, whereby there exists an optical path through said mask and said pellicle in which modulated light does not pass through said mask plate.

7. An electrically programmable photolithography mask as claimed in claim 1 wherein said solid state electro-opaque structure addressed by said row and column electrodes comprises a multiplayer structure.

8. An electrically programmable photolithography mask as claimed in claim 7 wherein said layers include one or more of an active material layer, an ionic conductor layer, and an ion storage layer.

9. An electrically programmable photolithography mask as claimed in claim 7 wherein said solid state electro-opaque structure includes one or more barrier structures between said layers.

10. An electrically programmable photolithography mask as claimed in claim 8 wherein a barrier layer is disposed between said ionic conductor layer and said ion storage layer.

11. An electrically programmable photolithography mask as claimed in claim 8 wherein said ion storage layer includes one or more said barrier layers.

12. An electrically programmable photolithography mask as claimed in claim 9 wherein a said barrier layer comprises a metal or metal oxide layer.

13. An electrically programmable photolithography mask as claimed in claim 9 wherein a said barrier layer comprises a layer of increased density within said electro-opaque structure.

14. An electrically programmable photolithography mask as claimed in claim 9 wherein a said barrier layer comprises a quantum well or quantum barrier arrangement.

15. An electrically programmable photolithography mask as claimed in claim 1 further comprising electrical insulating separators between said electro-opaque structures of adjacent pixels.

16. An electrically programmable photolithography mask as claimed in claim 1 wherein said electro-opaque structure has an optical transmission at least one wavelength less than 500 nm variable between 20 percent transmission and 80 percent transmission by means of a voltage or electric field applied by said row and column electrodes.

17. An electrically programmable photolithography mask as claimed in claim 1 wherein said pixels of said mask are substantially mutually adjacent, and wherein said mask is operable in both a light field and a dark field mode.

18. An electrically programmable photolithography mask as claimed in claim 1 wherein a said electro-opaque pixel has a variable optical transmission, and wherein said pattern of optical modulation comprises a greyscale pattern of modulation.

19. An electrically programmable photolithography mask as claimed in claim 1 wherein said mask plate comprises a silicon-on-insulator substrate, and wherein said silicon is substantially absent from said substrate where said array of pixels is fabricated.

20. An electrically programmable photolithography mask as claimed in claim 19 including drive circuitry for driving at least some of said pixel addressing electrodes fabricated in said silicon.

21. An electrically programmable photolithography mask with memory to retain a programmed pattern after programming, the mask comprising:
a substrate bearing an array of electrically programmable solid state structures for programming to define a pattern of optical modulation to be implemented by said mask;
a plurality of electrodes for addressing said structures for said programming; and
a memory system associated with each said structure for retaining said pattern of optical modulation after said programming; and
wherein said memory system comprises a charge storage device.

22. An electrically programmable photolithography mask as claimed in claim 21 wherein said charge storage device includes a floating plate capacitor.

23. An electrically programmable photolithography mask with memory to retain a programmed pattern after programming, the mask comprising:
a substrate bearing an array of electrically programmable solid state structures for programming to define a pattern of optical modulation to be implemented by said mask;
a plurality of electrodes for addressing said structures for said programming; and
a memory system associated with each said structure for retaining said pattern of optical modulation after said programming; and
wherein said memory system comprises an active memory circuit, and wherein said mask includes a power supply for said active memory circuit.

24. An electronically programmable mask for controlling the transmission of electro-magnetic radiation, the mask comprising:
a semiconductor-on-insulator substrate including a region from which semiconductor is substantially absent;
an array of pixels each comprising an electrically programmable solid-state structure; and
a plurality of electrodes for addressing said pixels to program said mask with a pattern of transmission of said electromagnetic radiation.

25. A mask as claimed in claim 24 wherein said semiconductor comprises silicon, and wherein said electrodes are fabricated in a silicon-bearing region of said silicon-on-insulator substrate.

26. A mask as claimed in claim 24 wherein said semiconductor comprises silicon, and further comprising drive circuitry coupled to said electrodes to drive said electrodes, so wherein said drive circuitry is fabricated in a silicon-bearing region of said silicon-on-insulator substrate.

27. An electro-optical mask including an array of pixels, each pixel including first and second regions between which ions are reversibly moveable and having an opaqueness depending on the relative concentration of ions in one or more of the first and second regions and wherein, in use, the application of a voltage across the fist and second regions is used to control the concentration of ions in the first and second regions and hence the opaqueness of the pixel; characterized in that it further includes a barrier between the first and second regions for impeding the movement of ions between the first and second regions in at least one direction.

28. A method of fabricating a three-dimensional structure, the method comprising:
programming an electrically programmable photolithography mask to define a greyscale pattern of modulation on the mask for fabricating said structure;
coating a wafer with a photosensitive polymer or photoresist;
exposing said wafer using said programmed greyscale mask; and
developing said exposed wafer to define a three-dimensional shape using said polymer or photoresist.

29. A method as claimed in claim 28 wherein said three-dimensional shape includes at least one region having a substantially continuous, unstepped surface contour variation.

30. A system for fabricating a three-dimensional structure, the system including:
an electrically programmable photolithography mask; and
a system for programming an electrically programmable photolithography mask to define a greyscale pattern of modulation on the mask for fabricating said structure.
